(19) United States
(12) Patent Application Publication
(10) Pub. No.: US 2024/0334374 A1
(43) Pub. Date: Oct. 3, 2024

(54) Method And Apparatus For Model Performance Monitor For Positioning In Mobile Communications

(71) Applicant: MediaTek Singapore Pte. Ltd., Singapore (SG)

(72) Inventors: Pengli Yang, Shanghai (CN); Mingwei Jie, Shanghai (CN); Chiao-Yao Chuang, Hsinchu City (TW); Xuancheng Zhu, Shanghai (CN); Ye Huang, Shanghai (CN)

(21) Appl. No.: 18/616,233

(22) Filed: Mar. 26, 2024

(30) Foreign Application Priority Data
Mar. 30, 2023 (WO) PCT/CN2023/085210
Apr. 6, 2023 (WO) PCT/CN2023/086508
Mar. 20, 2024 (CN) CN202410323855.1

(51) Int. Cl. H04W 64/00; H04L 5/00; H04W 24/08

(52) U.S. Cl. CPC H04W 64/00; H04L 5/0051; H04W 24/08

(57) ABSTRACT

Various solutions for improving model performance monitor mechanism for artificial intelligence/machine learning (AI/ML) positioning with respect to an apparatus in mobile communications are described. The apparatus may receive model monitoring data from a network node. The apparatus may generate a model output by a positioning model based on the model monitoring data used as a model input. The apparatus may determine a model monitoring result based on the model output or transmit the model output to the network node.

### CROSS REFERENCE TO RELATED PATENT APPLICATION(S)

The present disclosure is part of a non-provisional application claiming the priority benefit of PCT Application No. PCT/CN2023/085210, filed 30 Mar. 2023, PCT Application No. PCT/CN2023/086508, filed 6 Apr. 2023, and CN Application No. 202410323855.1, filed 20 Mar. 2024. The contents of aforementioned applications are herein incorporated by reference in their entirety.

### TECHNICAL FIELD

The present disclosure is generally related to mobile communications and, more particularly, to model performance monitor mechanism for artificial intelligence/machine learning (AI/ML) positioning with respect to apparatus in mobile communications.

### BACKGROUND

Unless otherwise indicated herein, approaches described in this section are not prior art to the claims listed below and are not admitted as prior art by inclusion in this section.

In 5th-generation (5G) New Radio (NR) mobile communications, artificial intelligence (AI)/machine learning (ML) schemes are introduced to position an apparatus. However, when an apparatus uses an AI/ML model to perform positioning operations, the accuracy of AI/ML positioning operations may be deteriorated due to that the deployment scenario of the apparatus changed. For improving AI/ML model generalization capability, model monitoring is important. Accordingly, how to improve AI/ML model accuracy becomes an important issue in the newly developed wireless communication network. Therefore, there is a need to provide proper schemes to monitor model performance.

### SUMMARY

The following summary is illustrative only and is not intended to be limiting in any way. That is, the following summary is provided to introduce concepts, highlights, benefits and advantages of the novel and non-obvious techniques described herein. Selected implementations are further described below in the detailed description. Thus, the following summary is not intended to identify essential features of the claimed subject matter, nor is it intended for use in determining the scope of the claimed subject matter.

An objective of the present disclosure is to propose solutions or schemes that improving model performance monitor mechanism for artificial intelligence/machine learning (AI/ML) positioning with respect to apparatus in mobile communications.

In one aspect, a method may involve an apparatus receiving model monitoring data from a network node. The method may also involve the apparatus generating a model output by a positioning model based on the model monitoring data used as a model input. The method may further involve the apparatus determining a model monitoring result based on the model output or transmitting the model output to the network node.

In one aspect, a method may involve an apparatus receiving model monitoring data from a network node. The method may also involve the apparatus generating a first line of sight (LOS) result by an LOS model based on the model monitoring data used as a model input. The method may further involve the apparatus determining an estimation location of the apparatus according to the first LOS result. The method may further involve the apparatus determining a second LOS result according to the estimation location of the apparatus. The method may further involve the apparatus determining an LOS ratio information according to the first LOS result and the second LOS result.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising receiving, via the transceiver, model monitoring data from a network node. The processor may also perform operations comprising generating a model output by a positioning model based on the model monitoring data used as a model input. The processor may further perform operations comprising determining a model monitoring result based on the model output or transmitting the model output to the network node.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising receiving, via the transceiver, model monitoring data from a network node. The processor may also perform operations comprising generating a first LOS result by an LOS model based on the model monitoring data used as a model input. The processor may further perform operations comprising determining an estimation location of the apparatus according to the first LOS result. The processor may further perform operations comprising determining a second LOS result according to the estimation location of the apparatus. The processor may further perform operations comprising determining an LOS ratio information according to the first LOS result and the second LOS result.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIGS. 3A to 3C are diagrams depicting example scenarios under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improvement of model performance monitor mechanism for AI/ML positioning with respect to apparatus in mobile communications. According to the present disclosure, a number of possible solutions may be implemented separately or jointly. That is, although these possible solutions may be described below separately, two or more of these possible solutions may be implemented in one combination or another.

Regarding to AI/ML model performance monitor of the present disclosure, model monitoring data is received from a network node. The model monitoring data is inputted into a positioning model for generating a model output or is used to assist model monitoring. The model output is used to determine a model monitoring result with respect to model performance or transmitted to the network node. In some implementations, the model monitoring data may include monitoring assistance data and/or positioning reference signals and/or network node (e.g., gNB) coordinates. When the model monitoring data includes the monitoring assistance data, the monitoring assistance data is inputted into the positioning model for generating the model output. When the model monitoring data includes the positioning reference signals, the positioning reference signals needs to be pre-processed into channel delay profiles before being inputted into the positioning model. When the model monitoring data includes gNB coordinate, the UE can use the gNB coordinate to estimate the location of UE corresponding to each monitoring assistance data or positioning reference signal through traditional method, (e.g. Continuous Hop Area Network algorithm) and the calculated location is compared with the model output location to calculate the monitoring metric. In an example, CHAN algorithm may be used for estimating the location of UE based on DL TDOA.

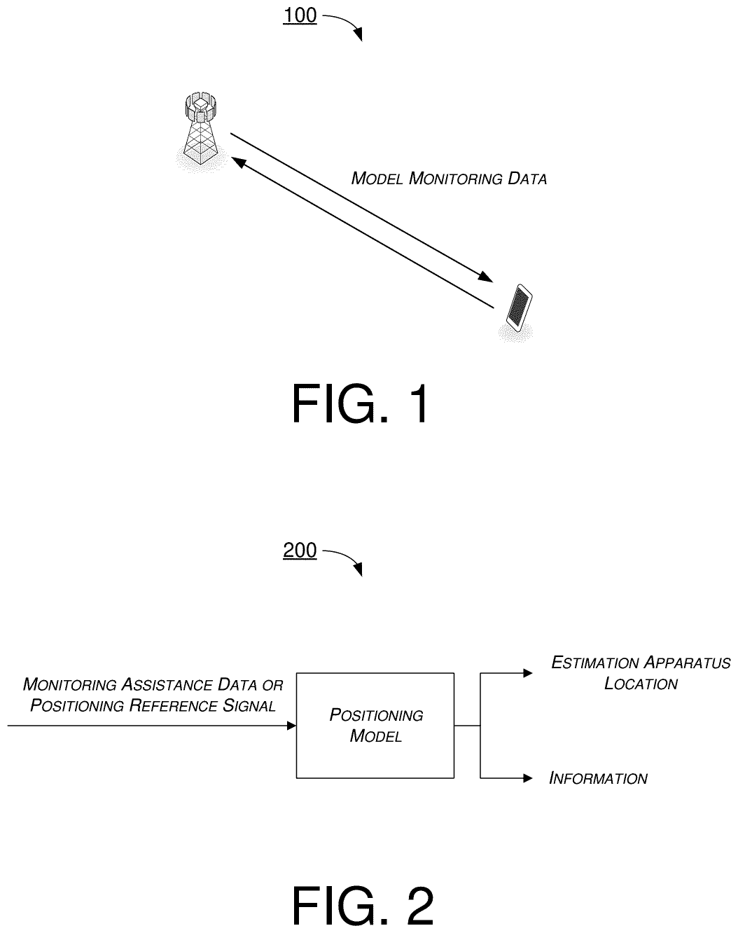

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates a current network framework in which UE may connect to one or more than one network nodes. The network node may transmit an indication and/or a model monitoring data to the UE. The UE may estimate the UE location via a direct AI/ML positioning or estimate the timing or LOS/NLOS indication via an AI/ML assisted positioning based on the model monitoring data. The UE may report the estimated UE location and soft information, when a model monitoring is performed by the network node. In addition, the UE may perform the model monitoring and report the result calculated based on monitoring metrics.

FIG. 2 illustrates an example scenario 200 under schemes in accordance with implementations of the present disclosure. After receiving the model monitoring data from the network node, the UE may generate a model output by a positioning model based on the model monitoring data used as a model input. In other words, the UE may input the model monitoring data into the positioning model for outputting the model output.

More specifically, the monitoring assistance data may include: (1) a plurality of channel delay profiles; and/or (2) a plurality of positioning labels corresponding to the channel delay profiles. Each of the channel delay profiles may include at least one of a channel impulse response (CIR), a power delay profile (PDP) and a reference signal received power (RSRP). Each of the positioning labels may include a location of the UE.

In some cases, the positioning model may include an AI/ML model (e.g., Mixture Density Network model) for receiving the channel delay profiles with corresponding positioning labels and generating an estimation apparatus location and a statistical information corresponding to correctness of the estimation apparatus location. In some cases, the positioning model may include an AI/ML model for receiving the channel delay profiles without corresponding positioning labels and generating an estimation apparatus location and a statistical information corresponding to correctness of the estimation apparatus location.

In some implementations, the statistical information corresponding to correctness of the estimation apparatus location may indicate accuracy of the estimation apparatus location. For example, the statistical information is a variance (or standard deviation) of the estimation apparatus location, the estimation apparatus location with smaller variance (or standard deviation) is more accurate than those the estimation apparatus location with larger variance.

In some implementations, after receiving the channel delay profiles (e.g., CIR, PDP and RSRP) with or without the positioning labels (i.e., the UE locations determined by the network node), the UE may input the channel delay profiles into the positioning model (e.g., AI/ML Mixture Density Network model) for outputting an estimation apparatus location and a statistical information including a value (e.g., a variance or a standard deviation) corresponding to correctness of the estimation apparatus location.

In some implementations, after generating the model output by the positioning model, the UE may: (1) determine a model monitoring result based on the model output; or (2) transmit the model output to the network node for the network node to determine a model monitoring result. Then, the UE may determine whether to retrain the positioning model, to switch to another positioning model or to adjust the positioning model according to the model monitoring result.

In some implementations, UE may report the legacy measurement to Location Measurement Function (LMF) for model monitoring in addition to the model output when the model monitoring data is the positioning reference signals. The LMF may estimate the location of UE based on reported measurement and compare it with UE reported location to assist UE side model monitoring.

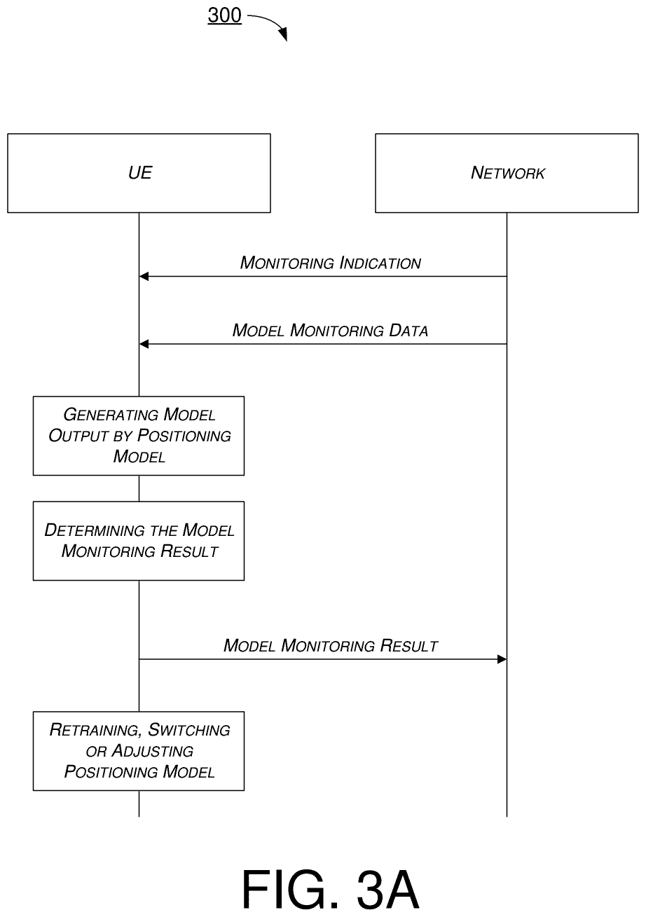

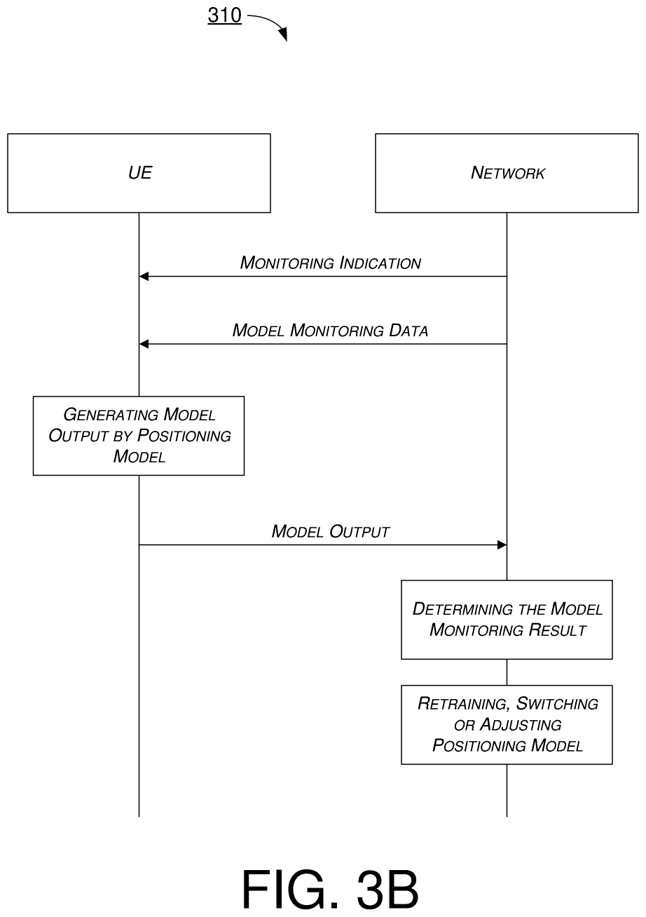

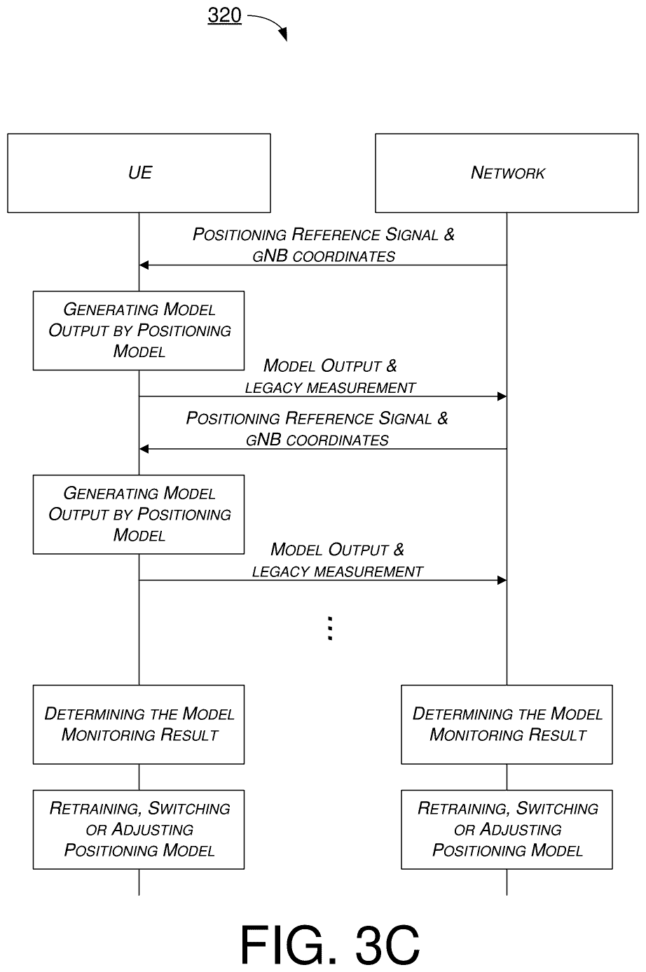

FIG. 3A illustrates an example scenario 300 under schemes in accordance with implementations of the present disclosure. In some implementations, the UE may receive a monitoring indication from the network node. The monitoring indication may indicate the UE to perform model monitoring operation. After receiving the monitoring indication, the UE may receive model monitoring data from the network node. The model monitoring dada may include a CIR, a PDP and an RSRP with or without ground truth label (e.g. UE location which may be determined by the network node), positioning reference signals and gNB coordinates.

The UE may generate a model output by the positioning model based on the model monitoring data used as the model input. In other words, the UE may input the model monitoring data into the positioning model for outputting the model output. The model output may include an estimation apparatus location and a statistical information corresponding to correctness of the estimation apparatus location. The statistical information may include a value (e.g., variance or a standard deviation) of the estimation apparatus location.

The UE may determine a model monitoring result according to the model output and determine whether to retrain the positioning model, to switch to another positioning model or to adjust the positioning model according to the model monitoring result. For example, the UE determines the model monitoring result based on whether the value of the statistical information is greater than a metric threshold. If positive, the UE determines to retrain the positioning model, to switch to another positioning model or to adjust the positioning model. If negative, the UE determines to keep applying the present positioning model. In some cases, after determining the model monitoring result, the UE may transmit the model monitoring result to the network node. In addition, the UE may determine the model monitoring result based on a difference between the estimation apparatus location and corresponding positioning label, or a difference between the estimation apparatus location and the location of the UE estimated based on gNB coordinates through a traditional method.

FIG. 3B illustrates an example scenario 310 under schemes in accordance with implementations of the present disclosure. In some implementations, the UE may receive a monitoring indication from the network node. The monitoring indication may indicate the UE to perform model monitor operation. After receiving the monitoring indication, the UE may receive model monitoring data from the network node. The model monitoring dada may include a CIR, a PDP and an RSRP with or without ground truth label. The model monitoring dada may further include positioning reference signals and gNB coordinates.

The UE may generate a model output by the positioning model based on the model monitoring data used as the model input. In other words, the UE may input the model monitoring data into the positioning model for outputting the model output. The model output may include an estimation apparatus location and a statistical information corresponding to correctness of the estimation apparatus location. The statistical information may include a value (e.g., variance or a standard deviation) of the estimation apparatus location.

The UE may transmit the model output and/or the legacy measurement to the network node for the network node to determine a model monitoring result and determine whether to retrain the positioning model, to switch to another positioning model or to adjust the positioning model according to the model monitoring result. If the network node determines to retrain the positioning model, to switch to another positioning model or to adjust the positioning model, the network node may transmit a message to inform the UE.

FIG. 3C illustrates an example scenario 320 under schemes in accordance with implementations of the present disclosure. In some implementations, the UE may receive model monitoring data from the network node. The model monitoring data may include reference signals and gNB coordinates. In an example, UE may estimate the channel delay profiles based on received reference signal and put it into model. In addition, UE may report the legacy measurement to network if the model output is reported.

The UE may generate a model output by the positioning model based on the model monitoring data used as the model input. In other words, the UE may input the model monitoring data into the positioning model for outputting the model output. More specifically, when the model monitoring data includes the monitoring assistance data, the monitoring assistance data is used as the model input directly. When the model monitoring data includes the positioning reference signals, the positioning reference signals needs to be pre-processed into channel delay profiles before being used as the model input.

The model output may include an estimation apparatus location and a statistical information corresponding to correctness of the estimation apparatus location. The statistical information may include a value (e.g., variance or a standard deviation) of the estimation apparatus location. The UE may transmit the model output to the network node.

The UE may repeat the operations of generating the model outputs and transmitting the model output and measurement result to the network node. Based on the model outputs and measurement result, both the UE and the network node may determine a model monitoring result and determine whether to retrain the positioning model, to switch to another positioning model or to adjust the positioning model according to the model monitoring result.

In some embodiments, the model monitoring result may be an evaluation value determined based on the estimation apparatus location and the corresponding statistical information according to the following formula:

loss=w₁*\sqrt{(xₖ−xₑ)²+(yₖ−yₑ)²}+w₂*ƒ(softᵥₐₗᵤₑ,xₑ,yₑ)

while loss is the evaluation value, (xₖ,yₖ) is the UE location determined/provided by the network node, or the location calculated by UE based on known gNB coordinates or based on measurement. (xₑ,yₑ) is the estimation location, softᵥₐₗᵤₑ is the value of the statistical information, and function ƒ is a transformation function. In some cases, w₁=0 and w₂=1 when ground truth label is not available (i.e., when the UE locations determined by the network node is not available).

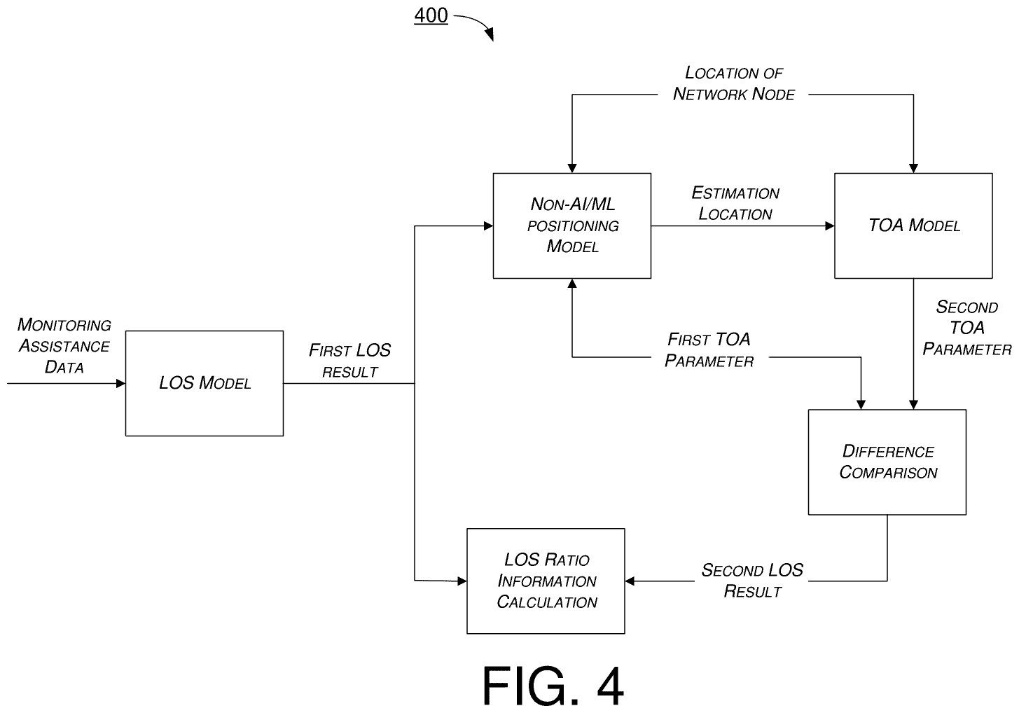

FIG. 4 illustrates an example scenario 400 under schemes in accordance with implementations of the present disclosure. After receiving the model monitoring data from the network node, the UE may generate a first line of sight (LOS) result by an LOS model based on the monitoring data used as a model input. In other words, the UE may input the model monitoring data into the LOS model for outputting the first LOS result.

After determining the first LOS result, the UE may determine an estimation location of the UE according to the first LOS result. The UE may determine a second LOS result according to the estimation location of the UE. The UE may determine an LOS ratio information according to the first LOS result and the second LOS result. The LOS ratio information may be used to evaluate AI/ML model performance.

In some implementations, the model monitoring data may include a monitoring assistance data which include a plurality of channel delay profiles. Each of the channel delay profiles may include at least one of a CIR, a PDP and an RSRP.

In some implementations, the LOS model may include an AI/ML model for receiving the channel delay profiles and generating the first LOS result. In some cases, the first LOS result may include LOS indicator indicating a corresponding path between the UE and the network node is LOS. In some cases, the first LOS result may include non-LOS (NLOS) indicator indicating a corresponding path between the UE and the network node is NLOS.

In some implementations, the UE may determine, using a non-AI/ML positioning method (such as time difference of arrival (TDOA) positioning method), the estimation location of the UE according to the first LOS result, a location of the network node (e.g., which may be transmitted from the network node) and a first time of arrival (TOA) parameter, which is a non-AI/ML generated parameter. In example, the first TOA parameter is the TOA for the path between the network node and UE, which is determined based on a non-AI conventional algorithm. In some implementations, the UE may estimate the TOA based on the positioning reference signals. In some cases, the first TOA parameter may be directly determined based on the time difference between transmitting time and receiving time for a signal.

In some implementations, before determining the second LOS result, the UE may generate a second TOA parameter by a TOA model based on the estimation location of the UE and the location of the network node both used as a model input. In other words, the UE may input the estimation location of the UE and the location of the network node into the TOA model for outputting the second TOA parameter. The second TOA parameter is calculated based on the distance between estimation location of the UE and the location of the network node and velocity of light via the TOA model. That is, the second TOA parameter is the TOA for the path between the network node and UE, which is determined based on an AI/ML model. After calculating the second TOA parameter, the UE may determine a difference according to the first TOA parameter and the second TOA parameter. Then, the UE may determine the second LOS result according to the difference.

In some implementations, the LOS ratio information may include at least one of an LOS ratio, an NLOS ratio and an LOS and NLOS ratio. In some cases, the first/second LOS result may include an LOS indicator indicating a corresponding path between the UE and the network node is LOS. The first/second LOS result may include an NLOS indicator indicating a corresponding path between the UE and the network node is NLOS. Accordingly, different ratios of LOS/NLOS/LOS&NLOS may be calculated based on the first LOS result(s) and the second LOS result(s).

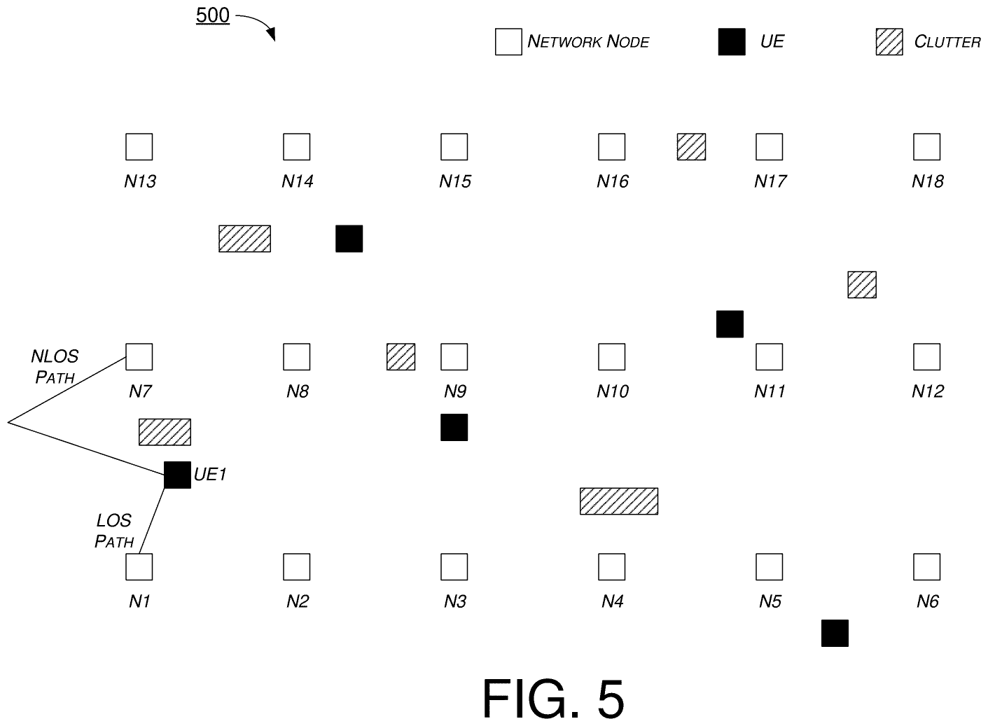

FIG. 5 illustrates an example scenario 500 under schemes in accordance with implementations of the present disclosure. Scenario 500 may illustrate a factory deployment. For example, there are 18 network nodes N1 to N18 in indoor factory and the locations of all network nodes are fixed. The UEs are randomly distributed in the factory. There are some clutters in the factory. In this scenario, some channel paths between the network nodes and the UEs are LOS paths, and some channel paths between the network nodes and the UEs are NLOS paths.

As shown in FIG. 5, the path between the UE1 and the network node N1 is an LOS path. The path between the UE1 and the network node N7 is an NLOS because a clutter obstructs the path between the UE1 and the network node N7. There is not any directly observable path but a reflection NLOS path between the UE1 and the network node N7.

Based on the mentioned operations, in this example, there are 18 LOS results for the UE1 using the AI/ML model (e.g., the mentioned LOS model). The estimation location of the UE1 is estimated according to the 18 LOS results based on TDOA positioning method. In this example, the distance between the UE1 and the network node N1 is 9 meters and TOA between the UE1 and the network node N1 is 9/c (TOA_NonAl₁) where c is speed of light. The distance between the UE1 and the network node N7 is 12 meters and the real TOA between the UE1 and the network node N7 is bigger than 12/c (TOA_NonAl₉) because this channel path is NLOS. In normal TDOA positioning method, whether the channel path is LOS or NLOS cannot be distinguished. When TOA of NLOS path is applied in TDOA positioning method, the positioning performance is getting worse. Therefore, the LOS model is introduced, and only LOS paths are chosen in TDOA positioning method which can improve the positioning performance. In this example, the non-AI/ML time of delay TOA_NonAl₁, TOA_NonAl₂, TOA_NonAl₃, TOA_NonAl₄, TOA_NonAl₈ and TOA_NonAl₉ are used in TDOA positioning method because the corresponding paths between the UE1 and the network nodes Nm are LOS paths while m=1, 2, 3, 4, 8 and 9.

After generating the estimation location of the UE1 and obtaining network locations for the network nodes, timing delay of every channel path between the UE1 and the network nodes are calculable by the following formula:

$${TOA\_Al}_{k} = \frac{\sqrt{{( {gNBx}_{k} - {UEx}_{e} )}^{2} + {( {gNBy}_{k} - {UEy}_{e} )}^{2}}}{c}$$

$$k = 1 : 18$$

while (gNBxₖ, gNByₖ) is the network node Nk location, (UExₑ, UEyₑ) is the estimation location of the UE1, TOA_AIₖ is timing delay between the UE1 and the network node Nk, and c is speed of light.

Accordingly, the differences diffₖ between TOA_NonAlₖ and TOA_AIₖ is calculable by the following formula:

$${diff}_{k} = abs ( {TOA}_{{NonAI}_{k}} - {TOA}_{{AI}_{k}} )$$

When the difference diffₖ is bigger than a threshold t1, then the corresponding path between the UE1 and the network node Nk is determined as an NLOS path. When the difference diffₖ is smaller than a threshold t2, then the corresponding path between the UE1 and the network node Nk is determined as an LOS path.

These non-AI/ML LOS results are compared with AI/ML LOS results from the LOS model. If a channel path is determined as an LOS path from LOS model but determined as an NLOS path based non-AI/ML result, then AL/ML detection of this path is false LOS detection. If a channel path is determined as an NLOS from LOS model but determined as an LOS path based on non-AI/ML result, then AL/ML detection of this path is false NLOS detection.

False LOS detection ratio ratio_falseLOS is the ratio of number of false LOS detection path and number of total LOS detection path according to the following formula:

$$ratio\_falseLOS = \frac{number of false LOS}{number of total LOS}$$

In an example, the path between the UE1 and the network node N4 is false LOS detection path, then ratio_falseLOS=1/6.

False NLOS detection ratio ratio_falseNLOS is the ratio of number of false NLOS detection path and number of total NLOS detection path according to the following formula:

$$ratio\_falseNLOS = \frac{number of false NLOS}{number of total NLOS}$$

In an example, (1) the path between the UE1 and the network node N9; and (2) the path between the UE1 and the network node N10 are false NLOS detection paths, then ratio_falseNLOS=2/12.

If false LOS detection ratio is bigger than a threshold t3, or false NLOS detection ratio is bigger than a threshold t4, the performance of the LOS model is worse, and the LOS model needs to be updated. Otherwise, the LOS model does not need to be updated.

### Illustrative Implementations

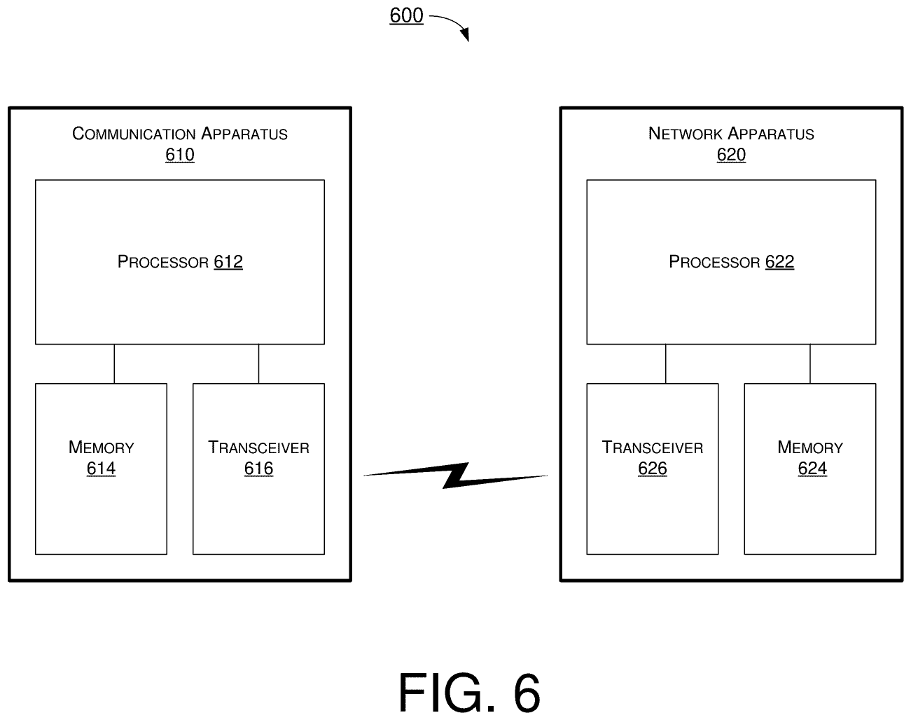

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to improvement of model performance monitor mechanism for artificial intelligence/machine learning (AI/ML) assisted positioning with respect to user equipment and network apparatus in mobile communications, including scenarios/schemes described above as well as process 700 and process 800 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of a network apparatus, which may be a network node such as a satellite, a base station, a small cell, a router or a gateway. For instance, network apparatus 620 may be implemented in an eNodeB in an LTE network, in a gNB in a 5G/NR, IoT, NB-IoT or IIoT network or in a satellite or base station in a 6G network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including autonomous reliability enhancements in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 520 is provided in the context of a mobile communication environment in which communication apparatus 610 is implemented in or as a communication apparatus or a UE and network apparatus 620 is implemented in or as a network node of a communication network.

In some implementations, processor 612 may receive, by the transceiver 616, model monitoring data from network apparatus 620. Processor 612 may generate a model output by a positioning model based on the model monitoring data used as a model input. Processor 612 may determine a model monitoring result based on the model output, or transmit, via the transceiver 616, the model output to network apparatus 620.

In some implementations, the model monitoring data includes at least one of monitoring assistance data and a positioning reference signal, and the monitoring assistance data includes a plurality of channel delay profiles.

In some implementations, the monitoring assistance data further includes a plurality of positioning labels corresponding to the channel delay profiles.

In some implementations, each of the channel delay profiles includes at least one of a channel impulse response (CIR), a power delay profile (PDP) and a reference signal received power (RSRP), and each of the positioning labels includes a ground truth label of the apparatus.

In some implementations, the model output includes an estimation apparatus location and a statistical information corresponding to correctness of the estimation apparatus location. The statistical information includes a value, and processor 612 may further determine the model monitoring result based on whether the value of the statistical information is greater than a metric threshold and based on a difference between the estimation apparatus location and corresponding positioning label.

In some implementations, the model monitoring data further includes the coordinates of network apparatus 620. In some implementations, the model output includes an estimation apparatus location and a statistical information corresponding to correctness of the estimation apparatus location. The statistical information includes a value, and processor 612 may further determine the model monitoring result based on whether the value of the statistical information is greater than a metric threshold and based on a difference between the estimation apparatus location and a location of the communication apparatus 610 calculated based on the coordinates of network apparatus 620.

In some implementations, the value includes a variance or a standard deviation of the estimation apparatus location.

In some implementations, processor 612 may further transmit, via the transceiver 616, the model monitoring result to network apparatus 620 after determining the model monitoring result.

In some implementations, processor 612 may further determine whether to retrain the positioning model, to switch to another positioning model or to adjust the positioning model according to the model monitoring result.

In some implementations, processor 612 may further receive, via the transceiver 616, a monitoring indication from network apparatus 620.

In some implementations, processor 612 may report a legacy measurement to Location Measurement Function (LMF) for monitoring.

In some implementations, processor 612 may receive, via the transceiver 616, model monitoring data from network apparatus 620. Processor 612 may generate a first LOS result by an LOS model based on the model monitoring data used as a model input. Processor 612 may determine an estimation location of the apparatus according to the first LOS result. Processor 612 may determine a second LOS result according to the estimation location of the apparatus. Processor 612 may determine an LOS ratio information according to the first LOS result and the second LOS result.

In some implementations, the model monitoring data includes at least one of monitoring assistance data, and the monitoring assistance data includes a plurality of channel delay profiles.

In some implementations, each of the channel delay profiles includes at least one of a channel impulse response, a power delay profile and a reference signal received power.

In some implementations, processor 612 may further determine the estimation location of the apparatus according to the first LOS result, a location of network apparatus 620 and a first TOA parameter.

In some implementations, processor 612 may further receive, via the transceiver 616, the location of network apparatus 620 from network apparatus 620.

In some implementations, processor 612 may further calculate a second TOA parameter based on both the estimation location of the apparatus and the location of network apparatus 620.

In some implementations, processor 612 may further determine a difference according to the first TOA parameter and the second TOA parameter. Processor 616 may further determine the second LOS result according to the difference.

In some implementations, the LOS ratio information includes at least one of an LOS ratio, an NLOS ratio and an LOS and NLOS ratio.

In some implementations, processor 612 may further determine whether to retrain the LOS model, to switch to another LOS model or to adjust the LOS model according to the LOS ratio information.

### Illustrative Processes

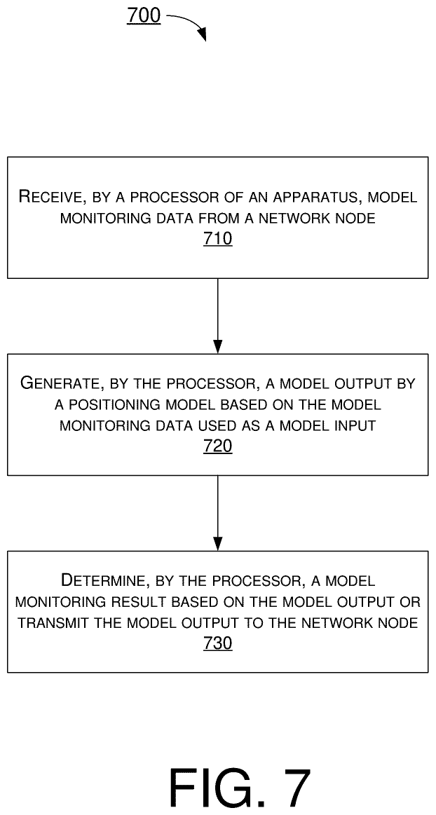

FIG. 7 illustrates an example process 700 in accordance with an implementation of the present disclosure. Process 700 may be an example implementation of above scenarios/schemes, whether partially or completely, with respect to improvement of model performance monitor mechanism of the present disclosure. Process 700 may represent an aspect of implementation of features of communication apparatus 610. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At 710, process 700 may involve processor 612 of communication apparatus 610 receiving model monitoring data from a network node. Process 700 may proceed from 710 to 720.

At 720, process 700 may involve processor 612 generating a model output by a positioning model based on the model monitoring data used as a model input. Process 700 may proceed from 720 to 730.

At 730, process 700 may involve processor 612 determining a model monitoring result based on the model output, or transmitting, via the transceiver 616, the model output to the network node.

In some implementations, process 700 may further involve processor 612 determining the model monitoring result based on whether the value of a statistical information is greater than a metric threshold and based on a difference between the estimation apparatus location and corresponding positioning label.

In some implementations, process 700 may further involve processor 612 determining the model monitoring result based on whether the value of a statistical information is greater than a metric threshold and based on a difference between the estimation apparatus location and a location of the apparatus calculated based on the network node coordinates.

In some implementations, process 700 may further involve processor 612 transmitting, via the transceiver 616, the model monitoring result to the network node after determining the model monitoring result.

In some implementations, process 700 may further involve processor 612 determining whether to retrain the positioning model, to switch to another positioning model or to adjust the positioning model according to the model monitoring result.

In some implementations, process 700 may further involve processor 612 receiving a monitoring indication from the network node.

In some implementations, process 700 may further involve processor 612 reporting a legacy measurement to LMF for monitoring.

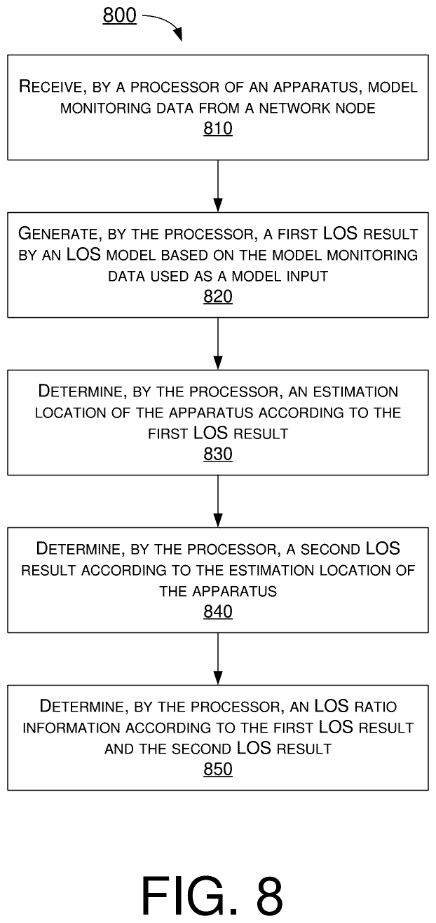

FIG. 8 illustrates an example process 800 in accordance with an implementation of the present disclosure. Process 800 may be an example implementation of above scenarios/schemes, whether partially or completely, with respect to improvement of model performance monitor mechanism of the present disclosure. Process 800 may represent an aspect of implementation of features of communication apparatus 610. Process 800 may include one or more operations, actions, or functions as illustrated by one or more of blocks 810 to 850. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by communication apparatus 610 or any suitable UE or machine type devices. Solely for illustrative purposes and without limitation, process 800 is described below in the context of communication apparatus 610. Process 800 may begin at block 810.

At 810, process 800 may involve processor 612 of communication apparatus 610 receiving model monitoring data from a network node. Process 800 may proceed from 810 to 820.

At 820, process 800 may involve processor 612 generating a first LOS result by an LOS model based on the model monitoring data used as a model input. Process 800 may proceed from 820 to 830.

At 830, process 800 may involve processor 612 determining an estimation location of the apparatus according to the first LOS result. Process 800 may proceed from 830 to 840.

At 840, process 800 may involve processor 612 determining a second LOS result according to the estimation location of the apparatus. Process 800 may proceed from 840 to 850.

At 850, process 800 may involve processor 612 determining an LOS ratio information according to the first LOS result and the second LOS result.

In some implementations, process 800 may further involve processor 612 determining the estimation location of the apparatus according to the first LOS result, a location of the network node and a first TOA parameter.

In some implementations, process 800 may further involve processor 612 receiving, via the transceiver 616, the location of the network node from the network node.

In some implementations, process 800 may further involve processor 612 calculating a second TOA parameter by a TOA model based on the estimation location of the apparatus and the location of the network node both used as a model input.

In some implementations, process 800 may further involve processor 612 determining a difference according to the first TOA parameter and the second TOA parameter, and determining the second LOS result according to the difference.

In some implementations, process 800 may further involve processor 612 determining whether to retrain the LOS model, to switch to another LOS model or to adjust the LOS model according to the LOS ratio information.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, model monitoring data from a network node;
generating, by the processor, a model output by a positioning model based on the model monitoring data used as a model input; and
determining, by the processor, a model monitoring result based on the model output, or transmitting, by the processor, the model output to the network node.

2. The method of claim 1, wherein the model monitoring data includes at least one of monitoring assistance data and a reference signal, and wherein the monitoring assistance data includes a plurality of channel delay profiles.

3. The method of claim 2, wherein the monitoring assistance data further includes a plurality of positioning labels corresponding to the channel delay profiles.

4. The method of claim 3, wherein each of the channel delay profiles includes at least one of a channel impulse response, a power delay profile and a reference signal received power, and wherein each of the positioning labels includes a ground truth label of the apparatus.

5. The method of claim 3, wherein the model output includes an estimation apparatus location and a statistical information, the statistical information includes a value, and the step of determining the model monitoring result based on the model output further comprises:
determining, by the processor, the model monitoring result based on whether the value of the statistical information is greater than a metric threshold and, based on a difference between the estimation apparatus location and corresponding positioning label.

6. The method of claim 1, wherein the model monitoring data further includes network node coordinates.

7. The method of claim 6, wherein the model output includes an estimation apparatus location and a statistical information, the statistical information includes a value, and the step of determining the model monitoring result based on the model output further comprises:
determining, by the processor, the model monitoring result based on whether the value of the statistical information is greater than a metric threshold and based on a difference between the estimation apparatus location and a location of the apparatus calculated based on the network node coordinates.

8. The method of claim 7, wherein the value includes a variance or a standard deviation of the estimation apparatus location.

9. The method of claim 1, further comprising: reporting, by the processor, a legacy measurement to Location Measurement Function (LMF) for monitoring.

10. The method of claim 1, further comprising:
transmitting, by the processor, the model monitoring result to the network node after determining the model monitoring result.

11. The method of claim 10, further comprising:
determining, by the processor, whether to retrain the positioning model, to switch to another positioning model or to adjust the positioning model according to the model monitoring result.

12. The method of claim 1, further comprising:
receiving, by the processor, a monitoring indication from the network node.

13. A method, comprising:
receiving, by a processor of an apparatus, model monitoring data from a network node;
generating, by the processor, a first line of sight (LOS) result by an LOS model based on the model monitoring data used as a model input;
determining, by the processor, an estimation location of the apparatus according to the first LOS result;
determining, by the processor, a second LOS result according to the estimation location of the apparatus; and
determining, by the processor, an LOS ratio information according to the first LOS result and the second LOS result.

14. The method of claim 13, wherein the model monitoring data includes monitoring assistance data, and wherein the monitoring assistance data includes a plurality of channel delay profiles.

15. The method of claim 14, wherein each of the channel delay profiles includes at least one of a channel impulse response, a power delay profile and a reference signal received power.

16. The method of claim 13, wherein the step of determining the estimation location of the apparatus further comprises:
determining, by the processor, the estimation location of the apparatus according to the first LOS result, a location of the network node and a first time of arrival (TOA) parameter.

17. The method of claim 16, further comprising:
receiving, by the processor, the location of the network node from the network node.

18. The method of claim 16, further comprising:
calculating, by the processor, a second TOA parameter based on both the estimation location of the apparatus and the location of the network node.

19. The method of claim 18, wherein the step of determining the second LOS result according to the estimation location of the apparatus further comprises:
determining, by the processor, a difference according to the first TOA parameter and the second TOA parameter; and
determining, by the processor, the second LOS result according to the difference.

20. The method of claim 13, wherein the LOS ratio information includes at least one of an LOS ratio, a non-LOS (NLOS) ratio and an LOS and NLOS ratio.

21. The method of claim 13, further comprising:
determining, by the processor, whether to retrain the LOS model, to switch to another LOS model or to adjust the LOS model according to the LOS ratio information.
